(19) United States
(12) Patent Application Publication
(10) Pub. No.: US 2003/0145217 A1
(43) Pub. Date: Jul. 31, 2003

(54) Writing-preventive device against computer viruses

(76) Inventor: Chao-Chen Kuo, Hsin-Chung City (TW)

Correspondence Address: SUPREME PATENT SERVICES, POST OFFICE BOX 2339, SARATOGA, CA, 95070, US

(21) Appl. No.: 10/057,697

(22) Filed: Jan. 25, 2002

(51) Int. Cl. G06F 12/14

(52) U.S. Cl. 713/200

(57) ABSTRACT

A writing-preventive device against computer viruses is electrically connected with a BIOS memory chip, a real time clock chip, and a CMOS chip respectively so as to prevent any data-writing action to any of the mentioned chips when the writing-preventive device is enabled. Besides, the writing-preventive device is mounted on a computer housing at a proper position for a user to reach and enable it easily.

### FIELD OF THE INVENTION

This invention relates to a writing-preventive device against computer viruses, particularly to a writing-preventive device having its actuator mounted on a computer housing.

### BACKGROUND OF THE INVENTION

In order to prevent a computer from being spoiled by some types of virus that are capable of invading a BIOS memory chip to erase the programs thereof or invading a CMOS chip to rewrite data or the real-time clock chip to result in a booting failure of the computer, a motherboard 10 shown in FIG. 1 is usually provided with a writing-preventive jumper 10b for protection of a BIOS memory chip 10a.

However, before doing so, a user has to read a motherboard handbook regarding the setting instructions of the writing-preventive jumper so that he/she can handle it correctly. The writing-preventive measure arranged in such a way is rather complicated to a major part of users and that is the point where this invention has tried to make improvements.

### SUMMARY OF THE INVENTION

The primary object of this invention is to provide a writing-preventive device for protecting data of chips on a computer motherboard against invasion of computer viruses, and the device is arranged in a way such that a user will reach and enable it easily.

In order to realize the object, the writing-preventive device of this invention is electrically connected with a BIOS memory chip, a real time clock chip, and a CMOS chip respectively so as to prevent any data-writing action to any of the mentioned chips when it is enabled. Moreover, the writing-preventive device is mounted on a computer housing at a proper position such that a user will reach and enable it easily.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 is a schematic view showing a conventional writing-preventive device arranged on a computer motherboard for protection of a BIOS memory chip;

FIG. 2 is a schematic view showing the framework of a writing-preventive device of this invention;

FIG. 3 shows a preferred embodiment of the writing-preventive device of this invention; and

FIG. 4 shows an on/off control switch of the writing-preventive device of this invention mounted on a computer housing.

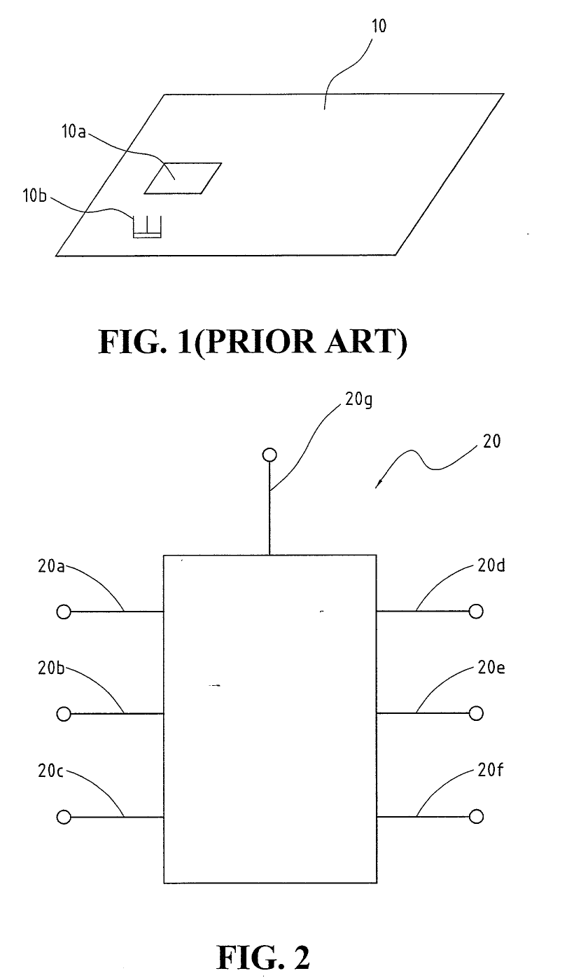

### DETAILED DESCRIPTION OF THE INVENTION

In a schematic view showing the framework of a writing-preventive device of this invention as indicated in FIG. 2, a writing-preventive device 20 is arranged to receive a plurality of input signals, including a R/\overline{W} signal 20a provided to a BIOS memory chip, a R/\overline{W} signal 20b provided to a real time clock chip, and a R/\overline{W} signal 20c provided to a CMOS chip on a computer motherboard. The writing-preventive device 20 then provides respective output signals to a R/\overline{W} signal pin 20d of the BIOS memory chip, a R/\overline{W} signal pin 20e of the real time clock chip, and a R/\overline{W} signal pin 20f of the CMOS chip. An enable/disable signal pin 20g of the writing-preventive device 20 will decide whether a writing action is to be taken for any of the mentioned chips.

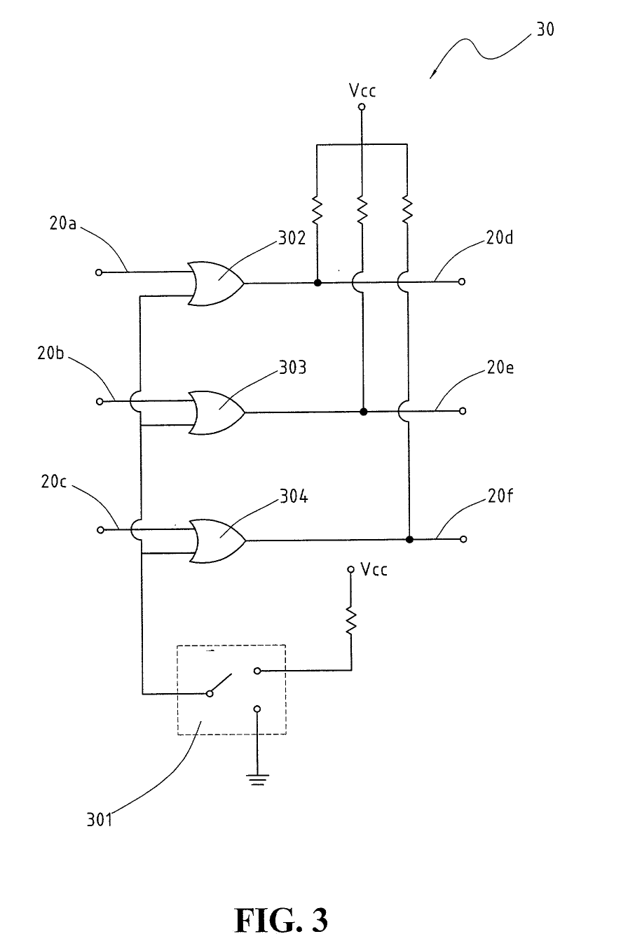

In FIG. 3, a writing-preventive device 30 is a preferred embodiment of the writing-preventive device of this invention composed of three OR gates 302, 303, 304 as well as an on/off control switch 301. When the on/off control switch 301 is switched to an electrically high level, the output of each OR gate, is “high” irrespective of the electrical level of the input signals 20a, 20b, 20c, namely, all the output signal pins 20d, 20e, 20f are “high” to have enabled the writing-preventive function to prohibit any writing action to the chips. On the contrary, when the on/off control switch 301 is switched to a low level, the writing-preventive function is disabled to permit the writing action to the chips.

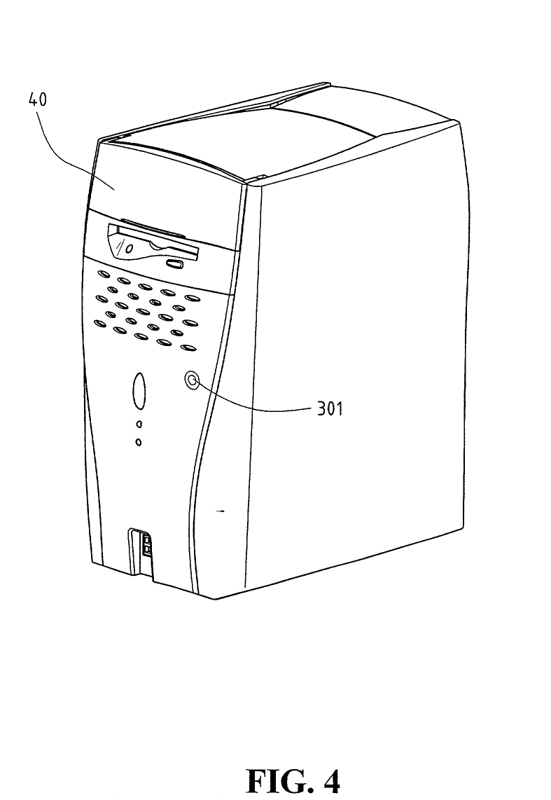

As indicated in FIG. 4, the on/off control switch 301 of the writing-preventive device of this invention is mounted on a computer housing 40 at a proper position that can facilitate enabling the writing-preventive device, adjacent to a power supply (not shown) for example.

A switch having mechanical contacts, a semiconductor switch, or an infrared-ray remote control switch might be adopted to serve for the on/off control switch 301.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A writing-preventive device against computer viruses, which is applied in a computer composed of at least a motherboard and a computer housing for accommodating the motherboard, in which the writing-preventive device is electrically connected with a BIOS memory chip, a real time clock chip, and a CMOS chip respectively so as to prevent any writing action to any of the chips when the writing-preventive device is enabled, in which the writing-preventive device is mounted on the computer housing at a proper position for a user to reach and enable it easily.

2. The writing-preventive device according to claim 1, which is electrically coupled to a R/\overline{W} signal pin of the BIOS memory chip, a R/\overline{W} signal pin of the real time clock chip, and a R/\overline{W} signal pin of the CMOS chip.

3. The writing-preventive device according to claim 1, which comprises at least an on/off control switch mounted on the housing for enabling or disabling a data-writing action to said chips.

4. The writing-preventive device according to claim 3, in which the on/off control switch is a switch having mechanical contacts.

5. The writing-preventive device according to claim 3, in which the on/off control switch is a semiconductor switch.

6. The writing-preventive device according to claim 3, in which the on/off control switch is an infrared-ray remote control switch.
